(19) United States
(12) Patent Application Publication
(10) Pub. No.: US 2008/0192621 A1
(43) Pub. Date: Aug. 14, 2008

(54) Data Communication System and Data Transmitting Apparatus

(76) Inventor: Naoki Suehiro, Ibaraki (JP)

Correspondence Address: LADAS & PARRY LLP, 224 SOUTH MICHIGAN AVENUE, SUITE 1600, CHICAGO, IL, 60604, US

(21) Appl. No.: 11/996,619

(22) PCT Filed: Jul. 7, 2006
(86) PCT No.: PCT/JP2006/313537

§ 371 Date: Mar. 17, 2008

(30) Foreign Application Priority Data
Jul. 27, 2005 (JP) 2005-217717

(51) Int. Cl. H04L 27/26

(52) U.S. Cl. 370/203

(57) ABSTRACT

A data communication system and a data transmitting apparatus with improved noise immunity are disclosed. The data communication system includes an orthogonal transforming unit using an N times N orthogonal matrix; a signal transforming unit; a transmitting unit; a receiving unit; a signal inverse-transforming unit; and an orthogonal inverse-transforming unit.

### BACKGROUND OF THE INVENTION

1. Field of the Invention

The present invention relates to a data communication system and a data transmitting apparatus including an orthogonal transforming unit.

2. Description of the Related Art

OFDM (Orthogonal Frequency Division Multiplexing) is used for reasons of the resistance to frequency selective fading, the tolerance to narrowband interference, the high efficiency of frequencies, and easy processing in the frequency domain.

FIG. 1(A) shows a transmitting apparatus 10 which includes an S/P (serial/parallel) conversion unit 11, a subcarrier modulation unit 12, an IDFT (Inverse Discrete Fourier Transform) unit 13, a prepseudo-periodic part inserting unit 14, a transmitting unit 15, an oscillator 16, and an antenna 17. The prepseudo-periodic part inserting unit 14 is generally referred to as a guard interval inserting unit.

Transmission data (for example, a digital information sequence) is converted into parallel signals by the S/P (serial/parallel) conversion unit 11. The converted parallel signals are modulated into subcarriers for the predetermined number of bits by the subcarrier modulation unit 12. A modulation scheme for subcarriers is selected from BPSK (Binary Phase Shift Keying), QPSK (Quadrature Phase Shift Keying), 16QAM (Quadrature Amplitude Modulation), and 64QAM. FIG. 4 shows a signal constellation for 64QAM.

The signal output from the subcarrier modulation unit 12 based on BPSK, QPSK, 16QAM, or 64QAM is transformed based on inverse-DFT (Inverse Discrete Fourier Transform), and then the plural subcarrier signals mutually having orthogonal relationships are transformed into a time-domain signal.

Then, the prepseudo-periodic part inserting unit 14 inserts a guard interval GI. Specifically, as shown in FIG. 2, the latter part of an effective symbol is copied and attached before the effective symbol, and the former part of the effective symbol is copied and attached after the effective symbol (the duration of the effective symbol is referred to as symbol time ST).

Alternatively, as shown in FIG. 3, the latter part of the effective symbol may be copied and attached before the effective symbol. The case where the latter part (2GI) of the effective symbol is copied and attached corresponds to FIG. 2.

The OFDM signal with the guard interval is transmitted from the antenna 17 after the transmitting unit 15 modulates the carrier output from the oscillator 16 (carrier frequency fₓ).

A receiving apparatus shown in FIG. 1(B) includes an antenna 21, a receiving unit 22, an oscillator 26, a prepseudo-periodic part removing unit 23, a DFT unit 24, and a P/S (parallel/serial) conversion unit 25.

The receiving apparatus shown in FIG. 1(B) performs operations in the reverse order for the transmitting apparatus 10. Specifically, the receiving unit 22 generates the OFDM baseband signal using the output from the oscillator 26. The prepseudo-periodic part removing unit 23 extracts the duration unaffected by the other symbols (effective symbol ST) from the OFDM baseband signal with propagation delay (for example, multipath delay).

Then, the OFDM signal is DFT-transformed by the DFT unit 24, and then parallel-to-serial converted by the P/S conversion unit 25. Finally, received data is output from the P/S conversion unit 25.

[Problem(s) to be Solved by the Invention]

Although the OFDM system is efficient, it has limited noise immunity, particularly when 64QAM is used for the modulation scheme for subcarriers.

In view of the aforementioned problem, it is a general object of the present invention to provide a data communication system and a data transmitting apparatus with improved noise immunity.

### SUMMARY OF THE INVENTION

In order to achieve the object of the present invention, a data communication system in one aspect of the present invention includes:

an orthogonal transforming unit using an N times N orthogonal matrix;

an OFDM transforming unit;

a transmitting unit;

a receiving unit;

an OFDM inverse-transforming unit; and

an orthogonal inverse-transforming unit;

wherein

the orthogonal transforming unit orthogonally transforms transmission data,

the OFDM transforming unit transforms the data orthogonally transformed by the orthogonal transforming unit into an OFDM baseband signal,

the transmitting unit transmits the OFDM baseband signal transformed by the OFDM transforming unit after transforming the OFDM baseband signal into a high frequency signal,

the receiving unit generates the OFDM baseband signal from the received high frequency signal,

the OFDM inverse-transforming unit OFDM-inverse-transforms the OFDM baseband signal generated by the receiving unit, and

the orthogonal inverse-transforming unit orthogonally inverse-transforms the orthogonally transformed signal output from the OFDM inverse-transforming unit.

Although an orthogonal matrix is typically intended for real numbers, the orthogonal matrix in the present invention includes not only real numbers but also complex numbers. Therefore, the orthogonal matrix in the present invention includes a Unitary matrix, an Hadamard matrix, and a DFT matrix.

Also, in order to achieve the object of the present invention, a modulation scheme for subcarriers in the OFDM baseband signal may be selected from BPSK, QPSK, 16QAM, and 64QAM.

Further, in order to achieve the object of the present invention, a data communication system in one aspect of the present invention includes:

an orthogonal transforming unit using an N times N orthogonal matrix;

a ZCZ transforming unit;

a transmitting unit;

a receiving unit;

a ZCZ inverse-transforming unit; and

an orthogonal inverse-transforming unit;

wherein

the orthogonal transforming unit orthogonally transforms transmission data,

the ZCZ transforming unit transforms the data orthogonally transformed by the orthogonal transforming unit into a ZCZ baseband signal,

the transmitting unit transmits the ZCZ baseband signal transformed by the ZCZ transforming unit after transforming the ZCZ baseband signal into a high frequency signal,

the receiving unit generates the ZCZ baseband signal from the received high frequency signal,

the ZCZ inverse-transforming unit ZCZ-inverse-transforms the ZCZ baseband signal generated by the receiving unit, and

the orthogonal inverse-transforming unit orthogonally inverse-transforms the orthogonally transformed signal output from the ZCZ inverse-transforming unit.

Also, in order to achieve the object of the present invention, the transform in the orthogonal transforming unit may be selected from a Unitary transform, an Hadamard transform, and a DFT transform.

Also, in order to achieve the object of the present invention, the orghogonal transforming unit may comprise N adders and plural orthogonal transforming devices using the N times N orthogonal matrix with N input terminals and N output terminals,

different data may be input to each input terminal in the orthogonal transforming devices,

the adders may add outputs from the corresponding output terminals in the plural orthogonal transforming devices, and

outputs from the orthogonal transforming unit may comprise outputs from the N adders.

Also, in order to achieve the object of the present invention, the transmission data may be input to the OFDM transforming unit after the transmission data is transformed from binary data to ternary data.

Also, in order to achieve the object of the present invention, a modulation scheme for subcarriers in the OFDM baseband signal may comprise a ternary QAM scheme.

Further, in order to achieve the object of the present invention, a data transmitting apparatus in one aspect of the present invention includes:

an orthogonal transforming unit using an N times N orthogonal matrix;

an OFDM transforming unit; and

a transmitting unit; wherein

the orthogonal transforming unit orthogonally transforms transmission data,

the OFDM transforming unit transforms the data orthogonally transformed by the orthogonal transforming unit into an OFDM baseband signal, and

the transmitting unit transmits the OFDM baseband signal transformed by the OFDM transforming unit after transforming the OFDM baseband signal into a high frequency signal.

Further, in order to achieve the object of the present invention, a data transmitting apparatus in one aspect of the present invention includes:

an orthogonal transforming unit using an N times N orthogonal matrix;

a ZCZ transforming unit; and

a transmitting unit; wherein

the orthogonal transforming unit orthogonally transforms transmission data,

the ZCZ transforming unit transforms the data orthogonally transformed by the orthogonal transforming unit into a ZCZ baseband signal, and

the transmitting unit transmits the ZCZ baseband signal transformed by the ZCZ transforming unit after transforming the ZCZ baseband signal into a high frequency signal.

Further, in order to achieve the object of the present invention, a data transmitting apparatus in one aspect of the present invention includes:

an orthogonal transforming unit using an N times N orthogonal matrix;

an OFDM transforming unit;

a ZCZ transforming unit;

a transmitting unit;

a transmission condition detecting unit; and

a transmission scheme switching unit;

wherein

the orthogonal transforming unit orthogonally transforms transmission data,

the OFDM transforming unit transforms the data orthogonally transformed by the orthogonal transforming unit into an OFDM baseband signal,

the ZCZ transforming unit transforms the data orthogonally transformed by the orthogonal transforming unit into a ZCZ baseband signal,

the transmitting unit transmits the OFDM baseband signal or the ZCZ baseband signal after transforming the OFDM baseband signal or the ZCZ baseband signal into a high frequency signal,

the transmission condition detecting unit detects a transmission condition, and

the transmission scheme switching unit switches between the OFDM transforming unit and the ZCZ transforming unit based on the transmission condition.

### EFFECT OF THE INVENTION

According to an embodiment of the present invention, it is possible to provide a data communication system and a data transmitting apparatus with improved noise immunity.

### BRIEF DESCRIPTION OF THE DRAWINGS

FIG. 1 shows a data communication system.

FIG. 2 shows a diagram for illustrating the case where guard intervals are provided before and after an effective symbol.

FIG. 3 shows a diagram for illustrating insertion of a guard interval.

FIG. 4 shows an 8 times 8 complex plane.

FIG. 5 shows a diagram for illustrating the principle of the present invention.

FIG. 6 shows a first Hadamard matrix.

FIG. 7 shows a second Hadamard matrix.

FIG. 8 shows an orthogonal transforming unit using a 10 dimensional Hadamard matrix.

FIG. 9 shows an example of a complete complementary sequence.

FIG. 10 shows an example of ZCZ sequences.

FIG. 11 shows a transmitting side in a data communication system.

FIG. 12 shows a receiving side in a data communication system.

FIG. 13 shows a ZCZ transforming unit.

FIG. 14 shows a diagram where plural orthogonal transforming units are used.

FIG. 15 shows a comparative table of multi-level QAM.

FIG. 16 shows a first data communication system.

FIG. 17 shows a second data communication system.

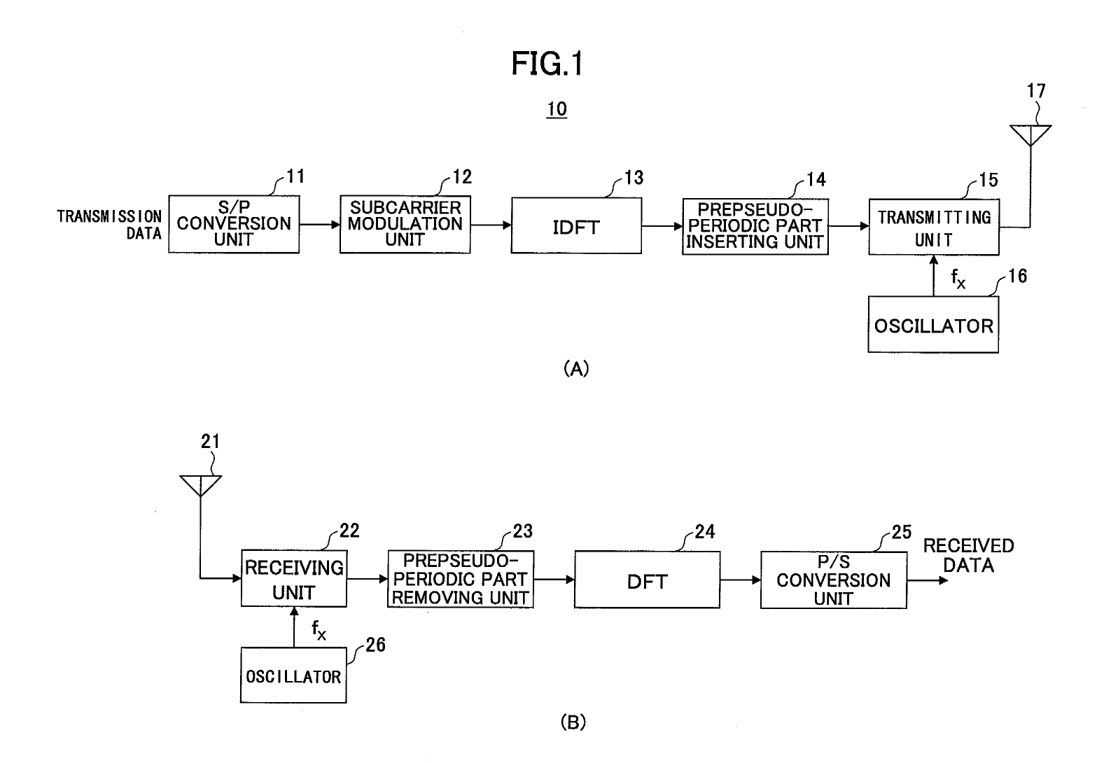

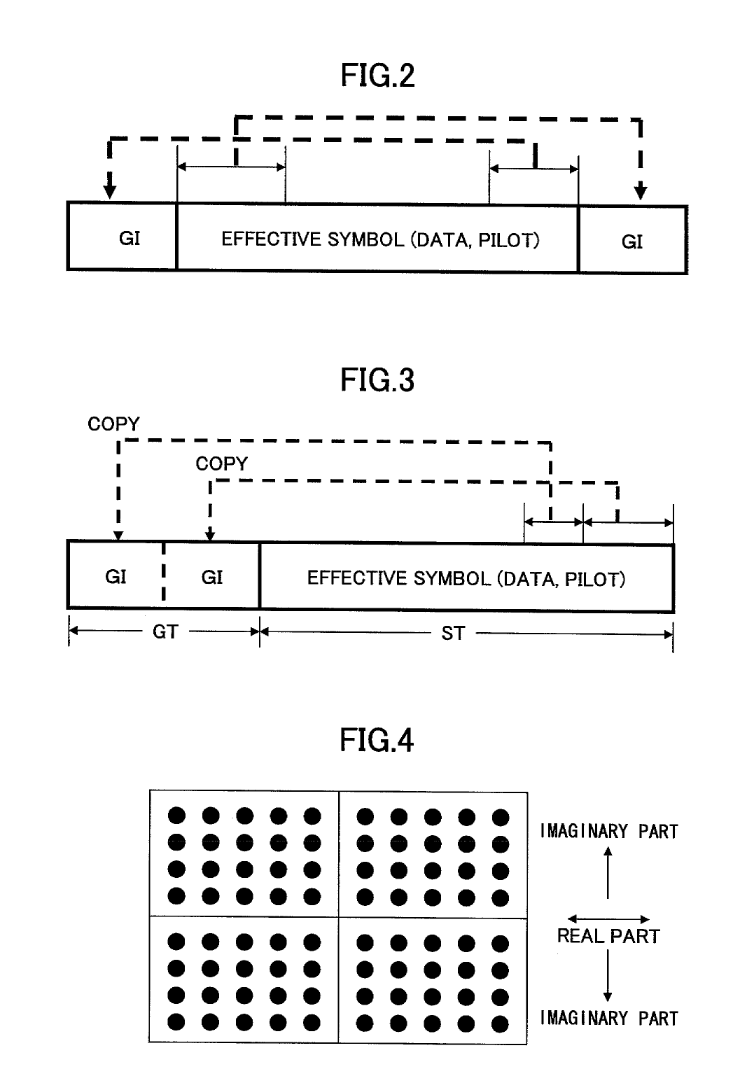

### DESCRIPTION OF THE PREFERRED EMBODIMENTS

### Description of Notations

31, 81, 91 orthogonal transforming unit
82, 82, 92 signal transforming unit
33, 85, 95 signal inverse-transforming unit
34, 86, 96 orthogonal inverse-transforming unit
41, 71, 72 Hadamard transforming unit
42, 55 P/S conversion unit
43 ZCZ transforming unit
44, 83, 93 transmitting unit
51, 84, 94 receiving unit
52 ZCZ inverse-transforming unit
53 S/P conversion unit
54 Hadamard inverse-transforming unit
97 transmission scheme switching unit
98 transmission condition detecting unit
99 switch signal detecting unit

### BEST MODE OF CARRYING OUT THE INVENTION

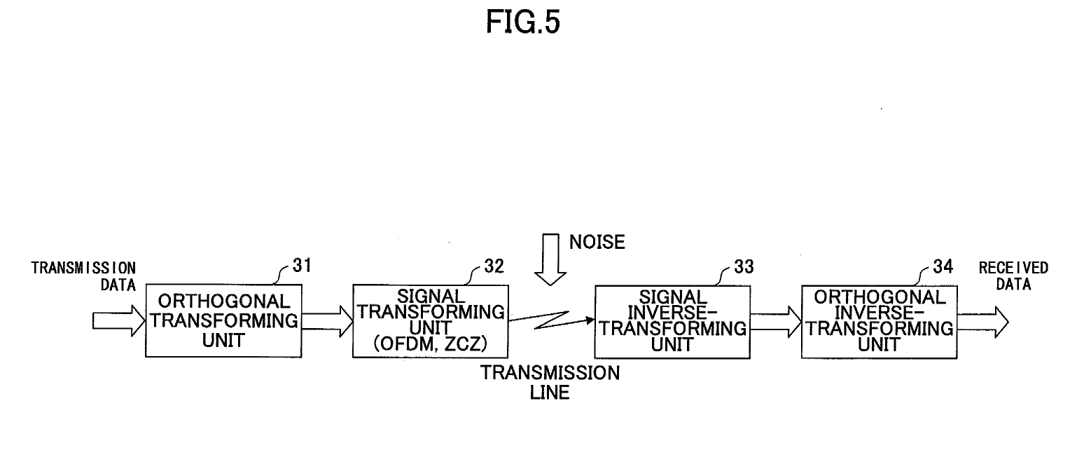

With reference to FIG. 5, the principle of the present invention is described. The system shown in FIG. 5 includes an orthogonal transforming unit 31, a signal transforming unit (for example, OFDM, ZCZ) 32, a signal inverse-transforming unit 33, and an orthogonal inverse-transforming unit 34.

The orghogonal transforming unit 31 orthogonally transforms transmission data using an N times N orthogonal matrix. The transform in the orthogonal transforming unit is selected from a Unitary transform, an Hadamard transform, and a DFT transform.

The signal transforming unit (for example, OFDM, ZCZ) 32 transforms the data orthogonally transformed by the orthogonal transforming unit 31 into an OFDM signal or a ZCZ signal for transmission. A transmission line may be selected from a wireless line, wired line, LAN, and so on.

The signal inverse-transforming unit 33 inverse-transforms the received OFDM signal or ZCZ signal and outputs the orthogonally transformed signal. The orthogonally transformed signal is inverse-transformed by the orthogonal inverse-transforming unit 34, and then received data is obtained.

According to an embodiment of the present invention, the orthogonal transforming unit 31 orthogonally transforms transmission data, and then the signal transforming unit (for example, OFDM, ZCZ) 32 transforms the transmission data into the signal for transmission.

Typically, transmission signals are influenced by external noise during transmission on the transmission line. According to the embodiment of the present invention, however, external noise has an influence on the orthogonally transformed signals, because the transmission data is orthogonally transformed. Because the signals are orthogonally transformed, noise is distributed among individual transmission data.

As a result, when the orthogonal inverse-transforming unit 34 inverse-transforms the received signals, the influence by the noise can be reduced. This is because noise applied to the individual transmission data is uncorrelated, and thus noise is cancelled during the inverse-transform by the orthogonal inverse-transforming unit 34.

In this manner, the embodiment of the present invention can provide a data communication system with improved noise immunity by orthogonally transforming transmission data.

[Orthogonal Transforming Unit]

The orthogonal transforming unit may use a 1024 times 1024 orthogonal matrix. Here, an example is described using the Hadamard transform.

The Hadamard transform is a kind of orthogonal transform, and uses herein a 10 dimensional matrix H(10) with elements selected from 1 and −1.

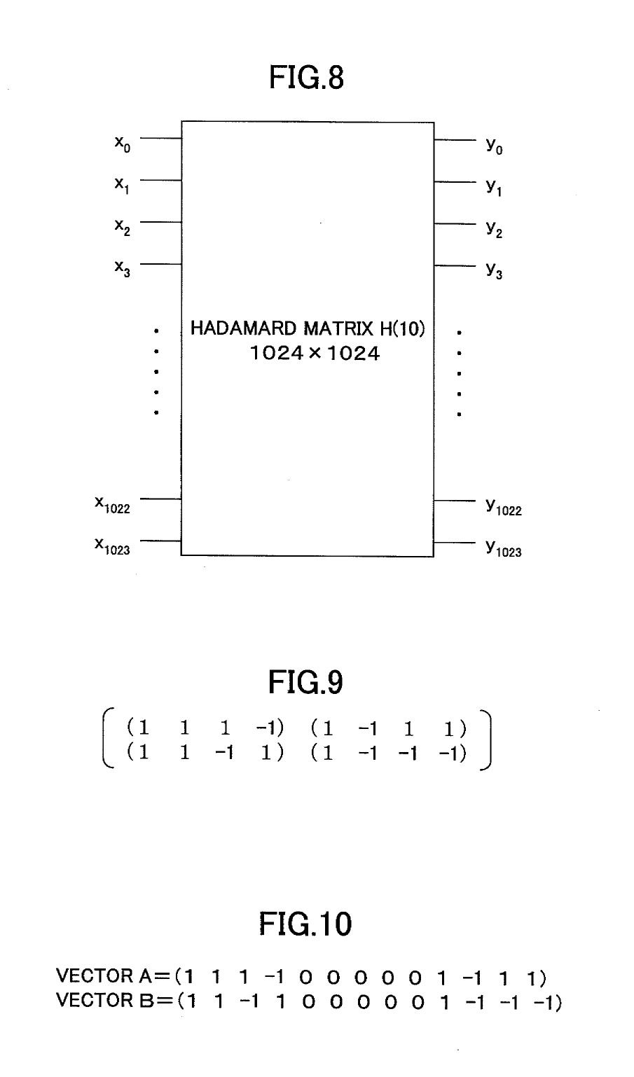

When time-series data {x}=x₀, x₁, . . . x₇ . . . is divided into signal groups each including 1024 bits and each of the divided signal groups is serial/parallel converted, a 10 dimensional Hadamard matrix can be used. Specifically, as shown in FIG. 8, input data X(x₀, x₁, . . . x₁₀₂₃)^{t} as parallel data (hereinafter, “t” represents a transposed matrix) is input to the 10 dimensional Hadamard matrix H(10), and Hadamard-transformed into output data Y(y₀, y₁, . . . y₁₀₂₃)^{t} according to the following equation (1).

Y=H(10)X (1)

According to this equation (1), the input data X(x₀, x₁, . . . x₁₀₂₃) t is transformed into the output data Y(y₀, y₁, . . . y₁₀₂₃)^{t}. It should be noted that X(x₀, x₁, . . . x₁₀₂₃) represents a time-domain signal and Y(y₀, y₁, . . . y₁₀₂₃) represents a frequency-domain signal.

Thus, each data x₀, x₁, . . . x₁₀₂₃ in the input data X has an influence on each data y₀, y₁, . . . y₁₀₂₃ in the output data Y.

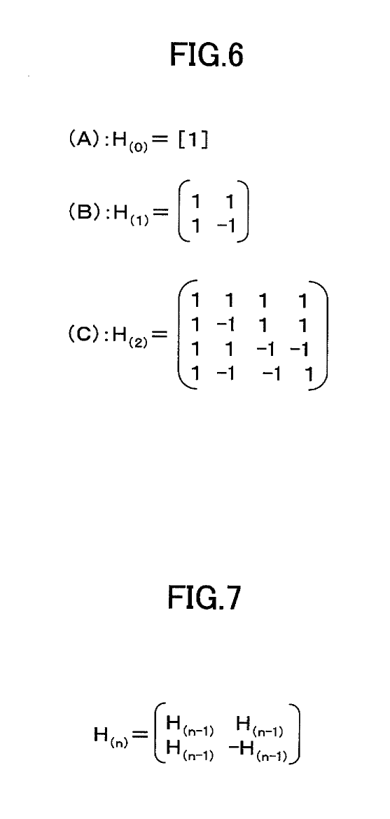

When the Hadamard matrix is expressed as H(0)=[1] as shown in FIG. 6(A), H(1) and H(2) are expressed as FIGS. 6(B) and 6(C).

Typically, an Hadamard matrix H(n) is expressed as a recurrence formula as shown in FIG. 7. Accordingly, a 10 dimensional matrix H(10) can be obtained. This 10 dimensional matrix H(10) is expressed as a 1024 times 1024 orthogonal matrix.

Instead of the Hadamard transform, the Unitary transform or the DFT transform may be used in the orthogonal transforming unit.

[Signal Transforming Unit]

The signal transforming unit is described using a ZCZ (Zero Correlation Zone) sequence.

The ZCZ sequence is generated from a complete complementary sequence, and is a one dimensional sequence whose auto-correlation function and cross-correlation function become zero within a certain range. FIG. 9 shows an example of a complete complementary sequence with the order of 8. FIG. 10 shows two ZCZ sequences generated from the complete complementary sequence with the order of 8 shown in FIG. 9. It should be noted that two ZCZ sequences are generated from a complete complementary sequence with 4 sets, and four ZCZ sequences are generated from a complete complementary sequence with 16 sets. It should be also noted that the ZCZ sequences may include any number of zeros (“0”) in FIG. 10, as long as the number of zeros in the vector A is equal to that in the vector B.

These ZCZ sequences can be used as spreading codes.

When the signal A shown in FIG. 10 is applied to a matched filter for the signal A, the following output is obtained.

000000080000000

When the signal A is applied to a matched filter for the signal B, the following output is obtained.

000000000000000

When the signal B shown in FIG. 10 is applied to the matched filter for the signal B, the following output is obtained.

000000080000000

When the signal B is applied to the matched filter for the signal A, the following output is obtained.

000000000000000

Therefore, the signals A and B can be used as spreading codes.

[Structure for the Transmitting Side]

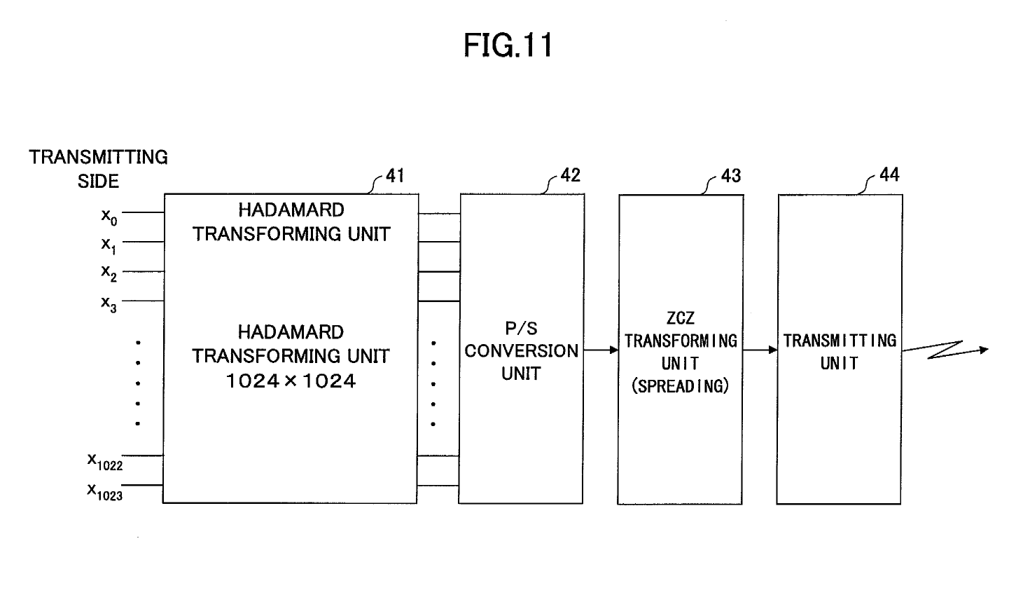

With reference to FIG. 11, the structure for the transmitting side using a ZCZ sequence in the signal transforming unit is described. The structure shown in FIG. 11 includes an Hadamard transforming unit 41, a P/S conversion unit 42, a ZCZ transforming unit 43, and a transmitting unit 44.

Time-series data {x}=x₀, x₁, . . . x₇ . . . is divided into signals each including 1024 bits, input data X(x₀, x₁, . . . x₁₀₂₃) t as the signal including 1024 bits is input to a 10 dimensional Hadamard matrix H41, and then output data Y(y₀, y₁, . . . y₁₀₂₃)^{t} is obtained.

The output data Y(y₀, y₁, y₁₀₂₃)^{t} is converted into a serial signal by the P/S conversion unit 42, and then output data Y(y₀, y₁, . . . y₁₀₂₃) is obtained.

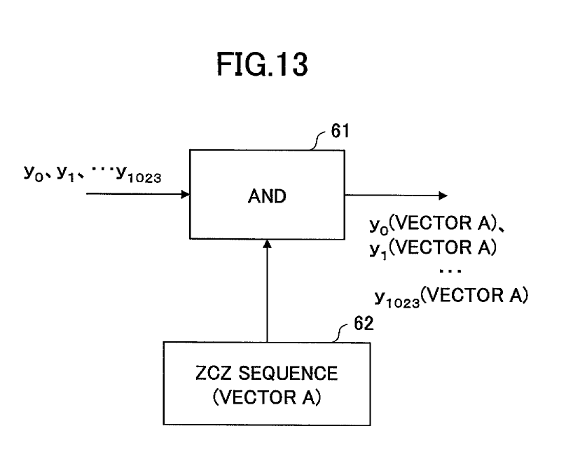

The ZCZ transforming unit 43 ZCZ-transforms the data Y(y₀, y₁, . . . y₁₀₂₃) to generate a ZCZ baseband signal. Specifically, as shown in FIG. 13, an AND circuit 61 performs an AND operation between the time-series data Y(y₀, y₁, . . . y₁₀₂₃) and the ZCZ sequence (for example, the vector A) 62. As a result, the AND circuit 61 outputs y₀(vector A), y₁(vector A), . . . y₁₀₂₃(vector A).

When the AND operation with the vector A is performed for each time slot for a bit in the output data Y, the vector A functions as a spreading sequence. In this case, the receiving side can reproduce the data Y(y₀, y₁, . . . y₁₀₂₃) using a matched filter.

It should be noted that the AND operation with the vector A may not be performed for each time slot for the bit in the output data Y. In this case, the receiving side can reproduce the data Y(y₀, y₁, . . . y₁₀₂₃) using a filter (correlator).

The signal (ZCZ baseband signal) which is ZCZ-transformed by the ZCZ transforming unit 43 is transformed into a high frequency signal for transmission by the transmitting unit 44.

[Structure for the Receiving Side]

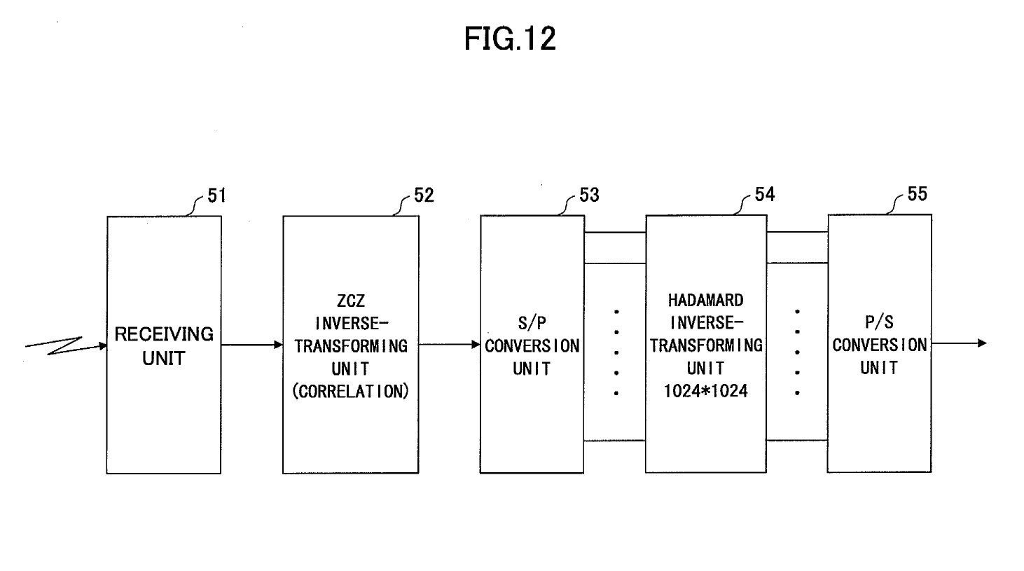

With reference to FIG. 12, the structure for the receiving side using a ZCZ sequence in the signal transforming unit is described. The structure shown in FIG. 12 includes a receiving unit 51, a ZCZ inverse-transforming unit 52, an S/P conversion unit 53, an Hadamard inverse-transforming unit 54, and a P/S conversion unit 55.

The receiving unit 51 receives the ZCZ-transformed signal to generate a ZCZ baseband signal. The ZCZ inverse-transforming unit 52 ZCZ-inverse-transforms the ZCZ baseband signal. Because the ZCZ-inverse-transformed signal is a serial signal, the S/P conversion unit 53 transforms the serial signal into parallel signals. Because the parallel signals are Hadamard-transformed signals, the Hadamard inverse-transforming unit 54 Hadamard-inverse-transforms the parallel signals. Because the Hadamard-inverse-transformed signals are parallel signals, the P/S conversion unit 55 converts the Hadamard-inverse-transformed signals into a serial signal to obtain received data.

### Embodiment Including Plural Orthogonal Transforming Units

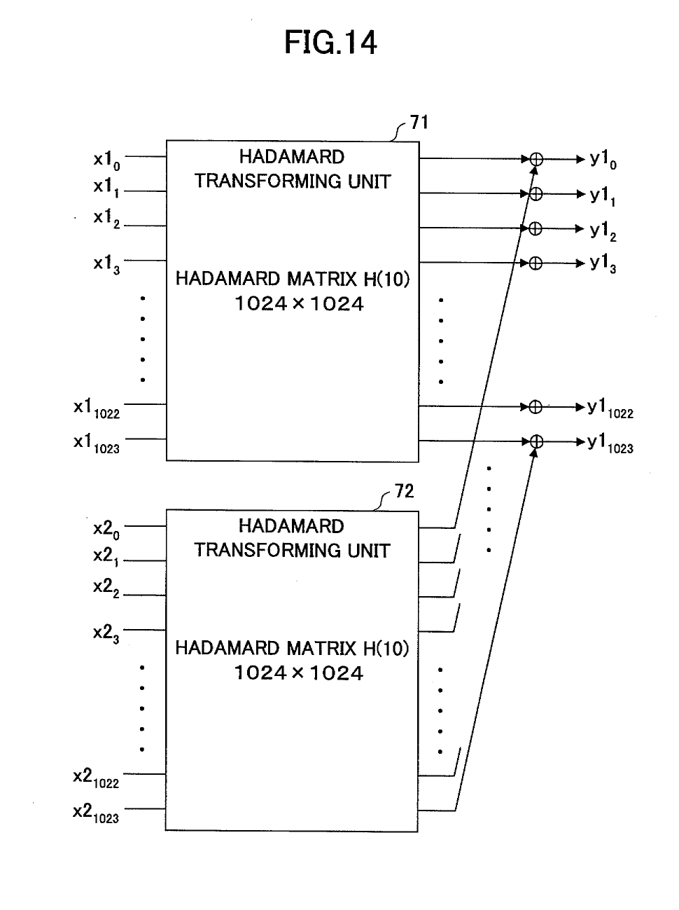

With reference to FIG. 14, an embodiment including plural orthogonal transforming units is described.

FIG. 14 shows an example using Hadamard transforming units 71 and 72. The structure shown in FIG. 14 includes the Hadamard transforming units 71 and 72 and 1024 adders.

It should be noted that the Unitary transform or the DFT transform may be used in the orthogonal transforming unit. It should be also noted that more than two orthogonal transforming units may be used in the present invention.

The Hadamard transforming units 71 and 72 use a 1024 times 1024 Hadamard matrix H(10). Input data (x1₀, x1₁, . . . x1₁₀₂₃) input to the Hadamard transforming unit 71 is different from input data (x2₀, x2₁, . . . x2₁₀₂₃) input to the Hadamard transforming unit 72.

The 1024 adders add outputs from the Hadamard transforming unit 71 and the corresponding outputs from the Hadamard transforming unit 72, and then output signals as if only one Hadamard transforming unit is present.

As with the structure shown in FIG. 5, this structure also improves noise immunity due to the orthogonal transforming unit.

Even if the Hadamard transforming units 71 and 72 do not have an orthogonal relationship with each other, interference can be reduced when they have a rotating relationship. Thus, when an error correction code is used in the transmission data, the receiving side can receive the data with few errors.

[Ternary QAM]

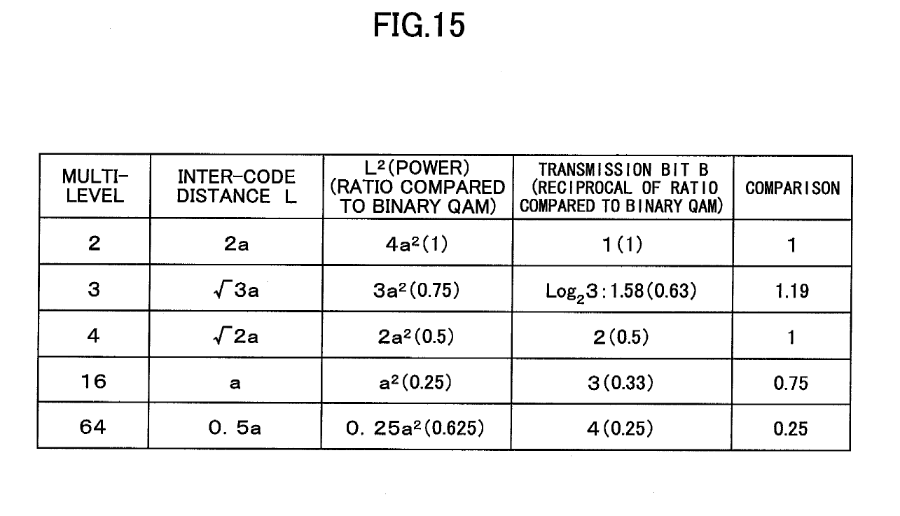

FIG. 15 shows comparisons among multi-level QAMs. Assuming that the inter-code distance for binary QAM is equal to 2a, the inter-code distances for ternary QAM, quarternary QAM, 16QAM, and 64QAM are equal to \sqrt{3}a, \sqrt{2}a, a, and 0.5a, respectively. When these inter-code distances are converted to powers, they are expressed as 4a², 3a², 2a², and 0.25a², respectively. In the table, the ratio compared to binary QAM is written with parentheses. This ratio is herein represented as R1.

The numbers of transmission bits per one digit for binary QAM, ternary QAM, quarternary QAM, 16QAM, and 64QAM are equal to 1, Log₂3, 2, 3, and 4, respectively. In the table, the reciprocal of the ratio compared to binary QAM is written with parentheses. This reciprocal of the ratio is herein represented as R2.

The column “comparison” in the table shows the ratio of R2 to R1. It is understood that ternary QAM is effective on noise.

Accordingly, when OFDM is used, modulating subcarriers by means of ternary QAM allows for efficient transmission.

When OFDM is used for the signal transforming unit 32 in FIG. 5 and subcarriers are modulated by means of ternary QAM, it is preferable that ternary data is input to the orthogonal transforming unit 31. Therefore, when subcarriers are modulated by means of ternary QAM in OFDM, a binary-to-ternary transforming circuit is provided in front of the orthogonal transforming unit 31 in order to input ternary data to the orthogonal transforming unit 31.

[Structure for a First Data Communication System]

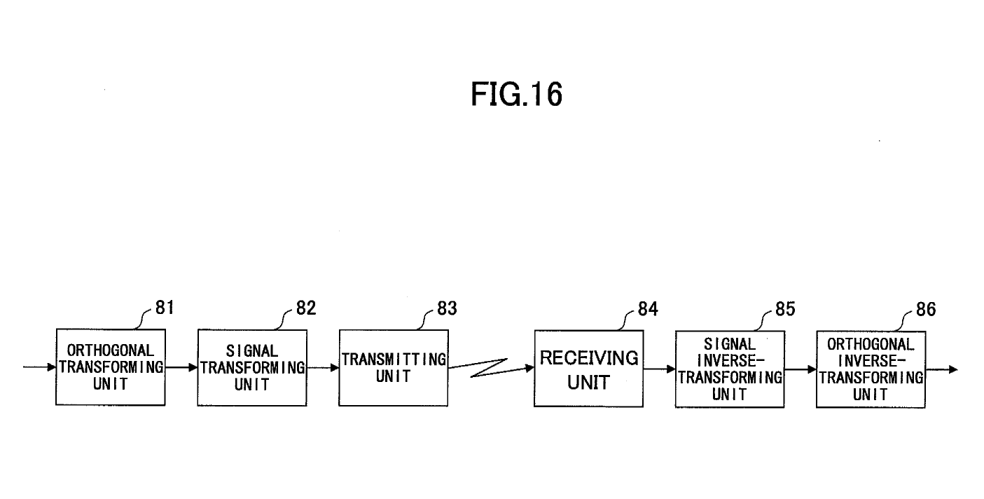

FIG. 16 shows a structure for a first data communication system. The structure shown in FIG. 16 includes an orthogonal transforming unit 81 using an N times N orthogonal matrix, a signal transforming unit 82 as an OFDM transforming unit or a ZCZ transforming unit, a transmitting unit 83, a receiving unit 84, a signal inverse-transforming unit 85 as an OFDM inverse-transforming unit or a ZCZ inverse-transforming unit, and an orthogonal inverse-transforming unit 86.

The orthogonal transforming unit 81 orthogonally transforms transmission data. The signal transforming unit 82 transforms the data orthogonally transformed by the orthogonal transforming unit 81 into an OFDM baseband signal or a ZCZ baseband signal. The transmitting unit 83 transmits the OFDM baseband signal or the ZCZ baseband signal transformed by the signal transforming unit 82 after transforming the OFDM baseband signal or the ZCZ baseband signal into a high frequency signal. The receiving unit 84 generates the OFDM baseband signal or the ZCZ baseband signal from the received high frequency signal. The signal inverse-transforming unit 85 inverse-transforms the OFDM baseband signal or the ZCZ baseband signal generated by the receiving unit 84. The orthogonal inverse-transforming unit 86 orthogonally inverse-transforms the orthogonally transformed signal output from the signal inverse-transforming unit 85.

[Structure for a Second Data Communication System]

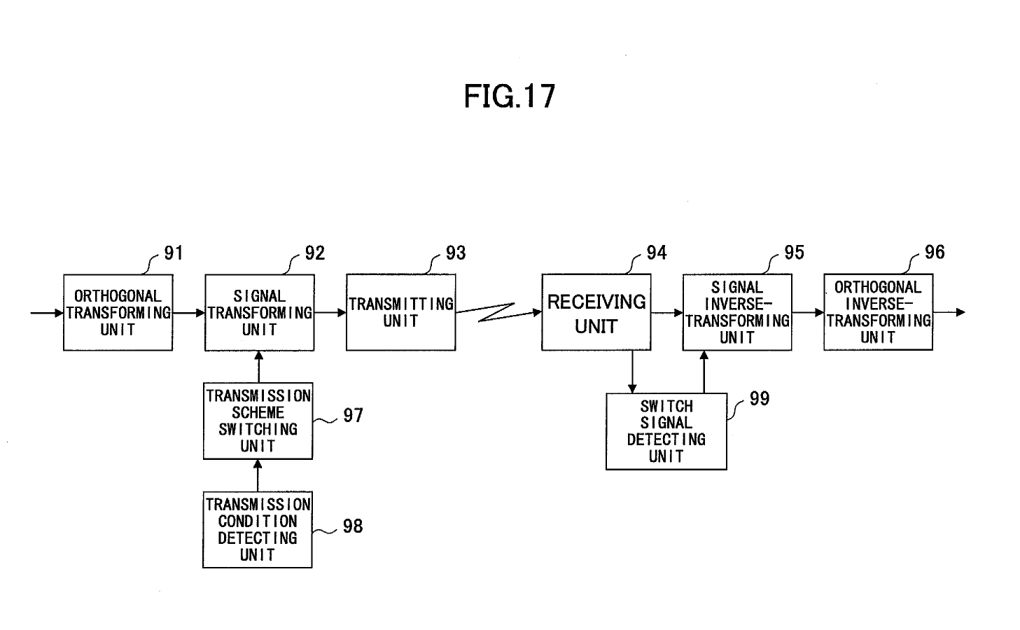

FIG. 17 shows a structure for a second data communication system. The structure shown in FIG. 17 further includes a transmission condition detecting unit 98, a transmission scheme switching unit 97, and a switch signal detecting unit 99, in addition to the structure shown in FIG. 16.

The second data communication system also includes an OFDM transforming unit and a ZCZ transforming unit in the signal transforming unit 92 and the signal inverse-transforming unit 95. The signal transforming unit 92 and the signal inverse-transforming unit 95 switch between the OFDM transforming unit and the ZCZ transforming unit to use either of them.

The transmission condition detecting unit 98 detects a transmission condition. The transmission scheme switching unit 97 switches the schemes for the signal transforming unit based on the transmission condition. It should be noted that the transmitting side transmits a switch signal to the receiving side in advance, upon switching the schemes for the signal transforming unit.

The receiving side detects the switch signal and switches the schemes for the signal inverse-transforming unit.

For example, although OFDM transmission where subcarriers are modulated by means of 64QAM has limited noise immunity, it improves the efficiency of transmission. On the other hand, although ZCZ transmission improves noise immunity, it has a limited efficiency of transmission.

Accordingly, the transmission scheme switching unit 97 switches the schemes, so that OFDM transmission where subcarriers are modulated by means of 64QAM is used in the case of low noise, and ZCZ transmission is used in the case of high noise.

The present invention is not limited to the aforementioned preferred embodiments thereof, so that various variations and changes are possible within the scope of the present invention.

The present application is based on Japanese Priority Application No. 2005-217717 filed on Jul. 27, 2005 with the Japanese Patent Office, the entire contents of which are hereby incorporated by reference.

What is claimed is:

1. A data communication system comprising:
an orthogonal transforming unit using an N times N orthogonal matrix;
an OFDM transforming unit;
a transmitting unit;
a receiving unit;
an OFDM inverse-transforming unit; and
an orthogonal inverse-transforming unit;
wherein
the orthogonal transforming unit orthogonally transforms transmission data,
the OFDM transforming unit transforms the data orthogonally transformed by the orthogonal transforming unit into an OFDM baseband signal,
the transmitting unit transmits the OFDM baseband signal transformed by the OFDM transforming unit after transforming the OFDM baseband signal into a high frequency signal,
the receiving unit generates the OFDM baseband signal from the received high frequency signal,
the OFDM inverse-transforming unit OFDM-inverse-transforms the OFDM baseband signal generated by the receiving unit, and
the orthogonal inverse-transforming unit orthogonally inverse-transforms the orthogonally transformed signal output from the OFDM inverse-transforming unit.

2. The data communication system as claimed in claim 1, wherein;
a modulation scheme for subcarriers in the OFDM baseband signal is selected from BPSK, QPSK, 16QAM, and 64QAM.

3. A data communication system comprising:
an orthogonal transforming unit using an N times N orthogonal matrix;
a ZCZ transforming unit;
a transmitting unit;
a receiving unit;
a ZCZ inverse-transforming unit; and
an orthogonal inverse-transforming unit;
wherein
the orthogonal transforming unit orthogonally transforms transmission data,
the ZCZ transforming unit transforms the data orthogonally transformed by the orthogonal transforming unit into a ZCZ baseband signal,
the transmitting unit transmits the ZCZ baseband signal transformed by the ZCZ transforming unit after transforming the ZCZ baseband signal into a high frequency signal,
the receiving unit generates the ZCZ baseband signal from the received high frequency signal,
the ZCZ inverse-transforming unit ZCZ-inverse-transforms the ZCZ baseband signal generated by the receiving unit, and
the orthogonal inverse-transforming unit orthogonally inverse-transforms the orthogonally transformed signal output from the ZCZ inverse-transforming unit.

4. The data communication system as claimed in any one of claims 1-3, wherein;
the transform in the orthogonal transforming unit is selected from a Unitary transform, an Hadamard transform, and a DFT transform.

5. The data communication system as claimed in any one of claims 1-4, wherein;
the orghogonal transforming unit comprises N adders and plural orthogonal transforming devices using the N times N orthogonal matrix with N input terminals and N output terminals,
different data is input to each input terminal in the orthogonal transforming devices,
the adders add outputs from the corresponding output terminals in the plural orthogonal transforming devices, and
outputs from the orthogonal transforming unit comprise outputs from the N adders.

6. The data communication system as claimed in any one of claims 1, 3, 4, 5, wherein;
the transmission data is input to the OFDM transforming unit after the transmission data is transformed from binary data to ternary data.

7. The data communication system as claimed in claim 6, wherein;
a modulation scheme for subcarriers in the OFDM baseband signal comprises a ternary QAM scheme.

8. A data transmitting apparatus comprising:
an orthogonal transforming unit using an N times N orthogonal matrix;
an OFDM transforming unit; and
a transmitting unit; wherein
the orthogonal transforming unit orthogonally transforms transmission data,
the OFDM transforming unit transforms the data orthogonally transformed by the orthogonal transforming unit into an OFDM baseband signal, and
the transmitting unit transmits the OFDM baseband signal transformed by the OFDM transforming unit after transforming the OFDM baseband signal into a high frequency signal.

9. A data transmitting apparatus comprising:
an orthogonal transforming unit using an N times N orthogonal matrix;
a ZCZ transforming unit; and
a transmitting unit; wherein
the orthogonal transforming unit orthogonally transforms transmission data,
the ZCZ transforming unit transforms the data orthogonally transformed by the orthogonal transforming unit into a ZCZ baseband signal, and
the transmitting unit transmits the ZCZ baseband signal transformed by the ZCZ transforming unit after transforming the ZCZ baseband signal into a high frequency signal.

10. A transmitting apparatus comprising:
an orthogonal transforming unit using an N times N orthogonal matrix;
an OFDM transforming unit;
a ZCZ transforming unit;
a transmitting unit;
a transmission condition detecting unit; and
a transmission scheme switching unit;
wherein
the orthogonal transforming unit orthogonally transforms transmission data,
the OFDM transforming unit transforms the data orthogonally transformed by the orthogonal transforming unit into an OFDM baseband signal,
the ZCZ transforming unit transforms the data orthogonally transformed by the orthogonal transforming unit into a ZCZ baseband signal,
the transmitting unit transmits the OFDM baseband signal or the ZCZ baseband signal after transforming the OFDM baseband signal or the ZCZ baseband signal into a high frequency signal,
the transmission condition detecting unit detects a transmission condition, and
the transmission scheme switching unit switches between the OFDM transforming unit and the ZCZ transforming unit based on the transmission condition.
